(19) United States
(12) Patent Application Publication
(10) Pub. No.: US 2017/0191312 A1
(43) Pub. Date: Jul. 6, 2017

(54) Ladder Accessory Device

(71) Applicant: Russell Durbin, JR., Westfield, NJ (US)

(72) Inventor: Russell Durbin, JR., Westfield, NJ (US)

(21) Appl. No.: 15/362,792

(22) Filed: Nov. 28, 2016

Related U.S. Application Data
(60) Provisional application No. 62/260,404, filed on Nov. 27, 2015.

(51) Int. Cl. E06C 7/14

(52) U.S. Cl. CPC E06C 7/143

(57) ABSTRACT

A ladder accessory device for holding paint and paint accessories on a ladder is provided. The ladder has a plurality of rungs with each rung having hollowed ends. The ladder accessory device comprises a Y-shaped mounting bracket having a first arm, a second arm opposite the first arm, and a base arm extending in a substantially opposite direction from the first arm and the second arm. A receiving bore is formed in the base arm. A rung shaft is receivable within the receiving bore of the base arm with the rung shaft receivable within the hollowed end of one of the rungs of the ladder. A circular support ring is pivotally mounted between the first arm and the second arm. The circular support ring supports the paint and paint accessories providing an effective means of managing and securing paint, tools, and accessories conveniently and safely within reach while working on the ladder.

### CLAIM OF PRIORITY

This patent application claims priority under 35 USC 119 (e) (1) from U.S. Provisional Patent Application Ser. No. 62/260,404 filed Nov. 27, 2015, of common inventorship herewith entitled, “Ladder Jockey,” which is incorporated herein by reference as though the same were set forth in its entirety.

### FIELD OF THE INVENTION

The present invention pertains to the field of ladder accessories, and more specifically to the field of paint container attachments releasably securable to a ladder.

### BACKGROUND OF THE INVENTION

The term do it yourself applies in its broadest sense to a range of tasks, usually domestic projects of repair or improvement, completed by individuals who are amateurs in the field. Instead of hiring professional contractors, many homeowners enjoy the challenge of learning new skills, adapting individual styles, and incorporating materials and techniques from local sources to beautify and improve their homes. The high degree of personal satisfaction and cost of labor savings provide substantial incentives for many do it yourselfers.

A ladder is an invaluable tool utilized by do it yourselfers as well as workers in a plethora of home improvement trades. For such professionals as construction workers, carpenters, contractors, electricians, and painters, these essential devices provide accessibility to ordinarily inaccessible locations. It is often necessary to utilize a wide variety of tools and accessories when working on a ladder. Whether nailing molding to a roofline, repairing wiring in overhead lighting, or removing paint from a ceiling, multiple tools are usually needed for a particular task.

While working on a ladder, there is no safe place to secure tools in between applications. If a worker sets tools down on a ladder's top level, the risk of inadvertently knocking them off and onto the floor rises dramatically, resulting in irreversible damage to these quite expensive instruments and perhaps a floor. A heavy tool falling from a high distance may cause injury to someone standing nearby. While placing the tools on a more stable surface such as a table or countertop helps prevent such damage and harm, having to climb off the ladder to retrieve a tool every time it is needed becomes time consuming and frustrating. Painters often find the top of ladders are an insufficient surface area for holding a paint can or tray. Lay painters and professionals who are balancing on a ladder and trying to work at the same time sometimes helplessly watch as paint receptacles go spiraling to the floor, resulting in one of the most daunting messes imaginable.

The prior art has put forth several designs for paint container attachments. Among these are:

U.S. Pat. No. 5,649,682 to Julius F. Martin describes a container holder for supporting a paint can or other item on a ladder using the interior of a hollow ladder rung for support. A flattened, rod like, projecting arm inserted into the rung is integrally formed with a completely encircling cincture for securing the container with over lapping members making up the arm held together under compression by a simple fastener at the point where the cincture and the support arm members join. When unfastened, the cincture is placed around the circumference of the paint can below the side handle protrusions or between them. The laterally extending top lip of the can with over lapping arm members are brought together in an overlapping manner and fastened together. The integral cincture and the overlapping projecting arm members are formed from one continuous strip of flat, flexible and preferably springy material which is rigid across its width and appropriately bent.

U.S. Pat. No. 4,824,060 to Edward S. Korda describes a paint can holder for hollow rung ladders. Paint cans usually are supported by a wire hook over a rung of a ladder and lie against one end of one of the side rails or depend from a rung on the rear side of a ladder leaning against a structure being painted. The present device includes a quickly detachable rod or shaft engaging through the hollow rung of an aluminum ladder and having a paint can supporting cradle on one end thereof in which the paint can is supported vertically in a convenient position relative to the ladder.

U.S. Pat. No. 4,776,550 to Willie J. Storey describes a holder for a paint bucket for attachment of the paint bucket to the side of a ladder. The holder includes a holder body secured by an indexing plate to a clamp so the clamp can attach the paint bucket holder body to the ladder. The indexing plate has notches on the lower, curved, outer periphery thereof with the plate being coupled rigidly to one side piece of the holder body. A vertical bar is rotatably mounted on the indexing plate and carries a beeper which is biased towards the lower periphery of the indexing plate so that the keeper enters a notch in the plate when the notch is aligned with one end of the keeper after the holder has been rotated to a predetermined angle relative to the clamp. In this way, the angle of tilt of the paint bucket is easily changed when desired or needed, yet the holder body will at all times safely and properly support a paint bucket at the desired level and angle with reference to the clamp.

None of these prior art references describe the present invention.

### SUMMARY OF THE INVENTION

It is an object of the present invention to provide a mounting bracket particularly configured for use on a ladder to hold a companion painting station as well as a handy tool receptacle tray.

The present invention is a ladder accessory device for holding paint and paint accessories on a ladder. The ladder has a plurality of rungs with each rung having hollowed ends. The ladder accessory device comprises a Y-shaped mounting bracket having a first arm, a second arm opposite the first arm, and a base arm extending in a substantially opposite direction from the first arm and the second arm. A receiving bore is formed in the base arm. A rung shaft is receivable within the receiving bore of the base arm with the rung shaft receivable within the hollowed end of one of the rungs of the ladder. A circular support ring is pivotally mounted between the first arm and the second arm. The circular support ring supports the paint and paint accessories providing an effective means of managing and securing paint, tools, and accessories conveniently and safely within reach while working on the ladder.

In addition, the present invention includes a method for holding paint and paint accessories on a ladder. The ladder has a plurality of rungs with each rung having hollowed ends. The method comprises providing a Y-shaped mounting bracket having a first arm, a second arm opposite the first arm, and a base arm extending in a substantially opposite direction from the first arm and the second arm, forming a receiving bore in the base arm, positioning a rung shaft within the receiving bore of the base arm, pivotally mounting a circular support ring between the first arm and the second arm, positioning the rung shaft within the hollowed end of one of the rungs of the ladder, supporting supports the paint and paint accessories within the support ring, and providing an effective means of managing and securing paint, tools, and accessories conveniently and safely within reach while working on the ladder.

The present invention further includes a ladder accessory device for holding paint and paint accessories on a ladder. The ladder has a plurality of rungs with each rung having hollowed ends. The ladder accessory device comprises a Y-shaped mounting bracket having a rounded first arm, a rounded second arm opposite the first arm, and a hollowed base arm extending in a substantially opposite direction from the first arm and the second arm. A first thumb screw extends through the first arm and a second thumb screw extends through the second arm. A rung shaft is receivable within the hollowed base arm with the rung shaft receivable within the hollowed end of one of the rungs of the ladder. A rung shaft securing thumb screw is threadably receivable within an aperture in the base arm for moving into and out of contact with the rung shaft thereby releasably securing at least a portion of the rung shaft within the base arm. A circular support ring is supported by the first thumb screw and the second thumb screw and pivotally mounted between the first arm and the second arm allowing the support ring to be leveled between the first arm and the second arms. The circular support ring supports the paint and paint accessories providing an effective means of managing and securing paint, tools, and accessories conveniently and safely within reach while working on the ladder.

### BRIEF DESCRIPTION OF THE DRAWINGS

FIG. 1 is a perspective view illustrating a ladder accessory device, constructed in accordance with the present invention, with the ladder accessory device attached to a ladder showing a magnetic brush mount and a paint screen.

FIG. 2 is a perspective view illustrating the ladder accessory device, constructed in accordance with the present invention, showing a mounting bracket with a rung shaft, a thumb screw, and a quart can support ring.

FIG. 3 is a perspective view illustrating the ladder accessory device, constructed in accordance with the present invention, showing the mounting bracket holding a magnetic base and an accessory tray.

FIG. 4 is a perspective view illustrating the ladder accessory device, constructed in accordance with the present invention, showing the mounting bracket holding a one gallon support ring, a removable canvas bag, a scraper holder, a bubble level, a bearing, and a lock ring.

FIG. 5 is a top plan view illustrating the lock ring of the ladder accessory device, constructed in accordance with the present invention.

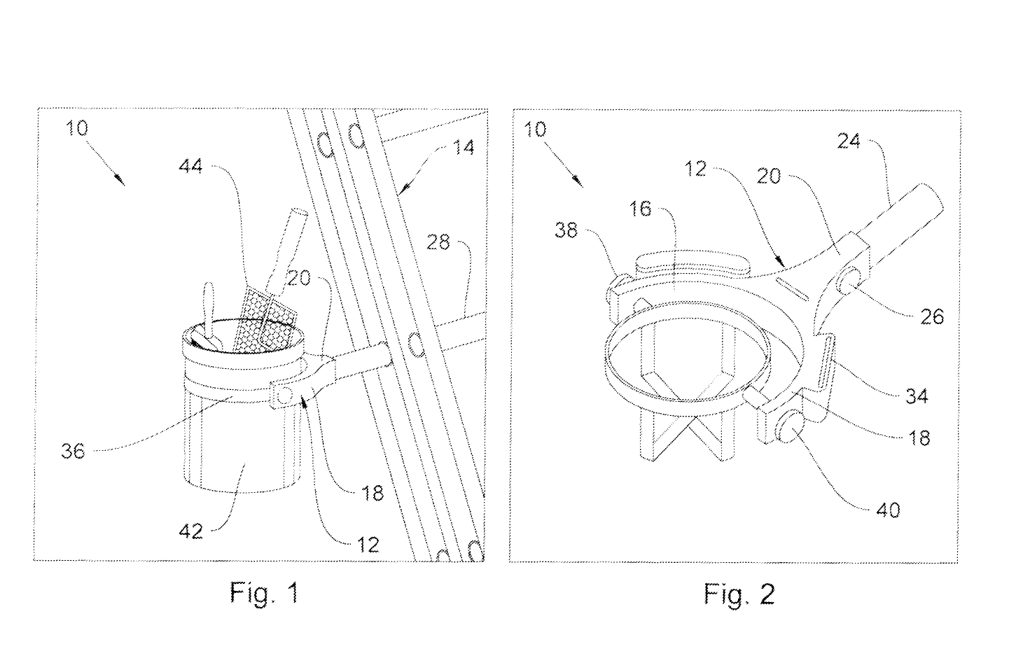

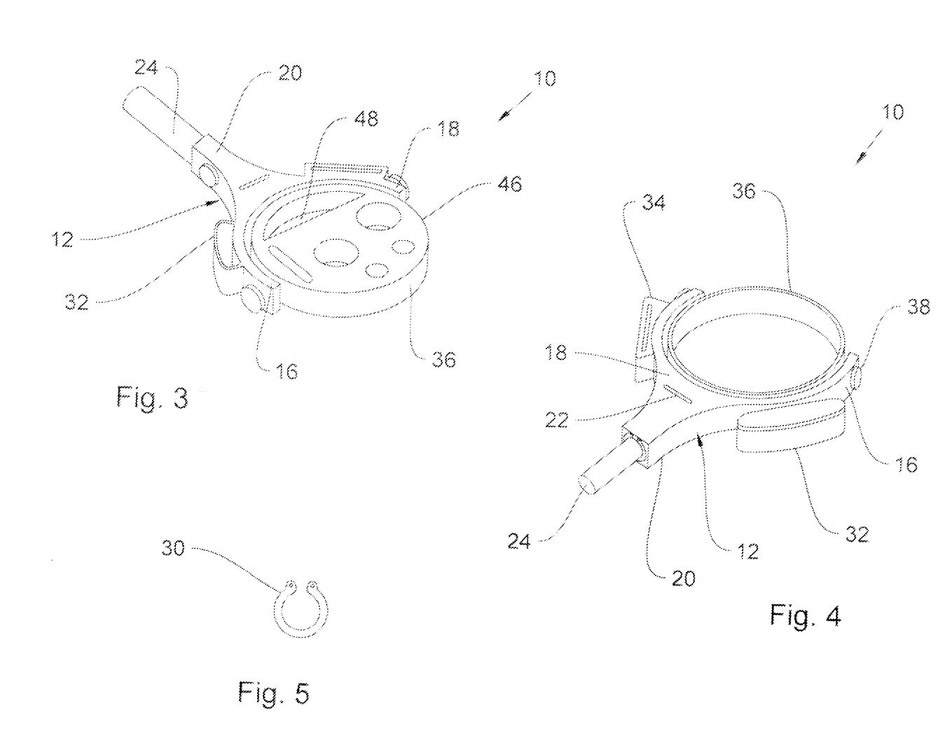

### DETAILED DESCRIPTION OF THE INVENTION

The present invention, hereinafter referred to as a Ladder Accessory Device, indicated generally at 10, is a mounting bracket 12 particularly configured for use on a ladder 14 to hold a companion painting station as well as a handy tool receptacle tray. The Ladder Accessory Device 10 provides an effective means of keeping all needed implements conveniently and safely within reach while working on the ladder 14. The Ladder Accessory Device 10 provides individual workers with an effective, hands-free means of managing and securing paint, tools, and accessories while working on the ladder 14.

The Ladder Accessory Device 10 of the present invention includes the mounting bracket 12. Preferably, the mounting bracket 12 is substantially Y-shaped having a first arm 16, a second arm 18 opposite the first arm 16, and a base arm 20 extending in a substantially opposite direction from the first arm 16 and the second arm 18. Preferably, the first arm 16 and the second arm 18 are rounded to better hold a paint can, as will be described further below. A bubble leveler 22 can be positioned on the mounting bracket 12 allowing the user to determine the levelness of the mounting bracket 12.

The base arm 20 of the Ladder Accessory Device 10 of the present invention preferably has a receiving bore formed therein for mounting the mounting bracket 12 to the ladder 14. A rung shaft 24 is receivable within the receiving bore of the base arm 20. A thumb screw 26 or the like threadably receivable within an aperture in the base arm 20 moves into and out of contact with the rung shaft 24 thereby releasably securing at least a portion of the rung shaft 24 within the base arm 20. The rung shaft 24 is receivable within a rung 28 of the ladder 14 and releasably secured therein by friction or other mechanical means to maintain the mounting bracket 12 at the appropriate and desired height and position. Facilitating attachment of the rung shaft 24 to the ladder 14 is a snap hook or lock ring 30 configuration extending from the present invention to securely fit onto the ladder rung 28. Actual use and operation of the Ladder Accessory Device 10 will be described in further detail below.

The Ladder Accessory Device 10 of the present invention further includes a removable canvas bag 32 mounted to the first arm 16 of the mounting bracket 12. The removable canvas bag 32 can be used to store various tools and/or implements a painter needs during use of the Ladder Accessory Device 10. Furthermore, second arm 18 of the mounting bracket 12 of the Ladder Accessory Device 10 of the present invention includes a mounting slot 34 for holding a paint scraper.

The first arm 16 and the second arm 18 of the mounting bracket 12 of the Ladder Accessory Device 10 of the present invention is configured to extend from the ladder 14 and spread on a side of the ladder 14 to flank a circular support ring 36 that is adjustable and levelable relative to the first arm 16 and the second arm 18 by means of a first thumb screw 38 extending through the first arm 16 and a second thumb screw 40 extending through the second arm 18. Preferably, the first thumb screw 38 and the second thumb screw 40 measure approximately three eighths (⅜″) inch in length. The open support ring 36 can suspend approximately one to two gallon cans of paint and a smaller insert accommodates a one quart can. The support ring 36 is pivotable relative to the mounting bracket 12 and keeps the support ring 36 at an even position while it is in use.

The Ladder Accessory Device 10 of the present invention can also include a special bucket receptacle 42 as an optional component available for insertion into the support ring 36 to house liquid paint, a brush, and a whizz roller. The interior back side of the bucket 42 comprises a gridded surface 44 that is employed to roll off excessive paint while using the paint roller. The tray insert 46 configured as a tool storage area is configured as a tool storage area featuring a magnetic base 48 and niches for housing such items as a hammer and screwdriver, wrenches and putty knives, measuring tapes, screws, chisels, nails, and chalk.

The Ladder Accessory Device 10 of the present invention houses a can of paint or other solutions in a bucket style receptacle 42 and comprises removable, compartmented trays 46. The Ladder Accessory Device 10 is preferably fabricated of a durable combination of plastic and aluminum materials.

Using the Ladder Accessory Device 10 of the present invention is simple and straightforward. A user attaches the Ladder Accessory Device 10 to the right or left side of the ladder 14 by inserting and locking its integrated rung shaft 20 into a ladder rung 28 of the ladder 14 at an appropriate working height. The user places and secures a paint can or cleaning solution in an integrated support ring 36. The user places needed tools and items in integrated compartments. The user then climbs the ladder 14 and begins the work project. When finished, the user removes the paint can and tools from the present invention and disassembles the Ladder Accessory Device 10 from the ladder rung 28. Easily portable, the Ladder Accessory Device 10 is expediently applied to and removed from virtually any type of ladder 14 in a matter of seconds. The Ladder Accessory Device 10 is neatly stored away until the next do it yourself project.

Using the Ladder Accessory Device 10 of the present invention, workers on ladders have a convenient, safe place to store tools and needed supplies while attending to the task at hand. Alleviating a risk that tools and supplies falling onto the floor, the Ladder Accessory Device 10 effectively functions to prevent costly replacement of tools as well as possible injury to others. The copious storage space for paint cans or cleaning solution containers efficiently keeps cans safely ensconced while working, alleviating a risk of messy spills and costly waste of paint or cleaning liquid. The Ladder Accessory Device 10 is highly functional for home do it yourselfers, painters, construction workers, electricians and other trade professionals. Compact, lightweight and durably constructed of high quality materials, the Ladder Accessory Device 10 will withstand years of continued use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A ladder accessory device for holding paint and paint accessories on a ladder, the ladder having a plurality of rungs, each rung having hollowed ends, the ladder accessory device comprising:
a Y-shaped mounting bracket having a first arm, a second arm opposite the first arm, and a base arm extending in a substantially opposite direction from the first arm and the second arm;
a receiving bore formed in the base arm;
a rung shaft receivable within the receiving bore of the base arm, the rung shaft receivable within the hollowed end of one of the rungs of the ladder; and
a circular support ring pivotally mounted between the first arm and the second arm;
wherein the circular support ring supports the paint and paint accessories providing an effective means of managing and securing paint, tools, and accessories conveniently and safely within reach while working on the ladder.

2. The ladder accessory device of claim 1 wherein the first arm and the second arm are rounded.

3. The ladder accessory device of claim 1 and further comprising:
a bubble leveler can be positioned on the mounting bracket.

4. The ladder accessory device of claim 1 and further comprising:
a rung shaft securing thumb screw threadably receivable within an aperture in the base arm for moving into and out of contact with the rung shaft thereby releasably securing at least a portion of the rung shaft within the base arm.

5. The ladder accessory device of claim 1 wherein the rung shaft is releasably secured within the hollowed end of the rung by friction.

6. The ladder accessory device of claim 1 and further comprising:
a lock ring for securing the rung shaft within the base arm of the mounting bracket.

7. The ladder accessory device of claim 1 and further comprising:
a removable canvas bag mounted to the first arm of the mounting bracket.

8. The ladder accessory device of claim 1 and further comprising:
a mounting slot formed on the second arm of the mounting bracket for releasably holding a paint scraper.

9. The ladder accessory device of claim 1 further comprising:
a first thumb screw extending through the first arm; and
a second thumb screw extending through the second arm;
wherein the first thumb screw and the second thumb screw support the support ring allowing the support ring to be leveled between the first arm and the second arms.

10. The ladder accessory device of claim 1 wherein the support ring suspend approximately one to two gallon cans of paint.

11. The ladder accessory device of claim 1 and further comprising:
an insert receivable within the support ring for accommodating a one quart can of paint.

12. The ladder accessory device of claim 1 and further comprising:
an accessory tray having a magnetic bottom receivable within the support ring.

13. The ladder accessory device of claim 1 and further comprising a bucket having a gridded surface receivable within the support ring.

14. A method for holding paint and paint accessories on a ladder, the ladder having a plurality of rungs, each rung having hollowed ends, the method comprising:
providing a Y-shaped mounting bracket having a first arm, a second arm opposite the first arm, and a base arm extending in a substantially opposite direction from the first arm and the second arm;
forming a receiving bore in the base arm;
positioning a rung shaft within the receiving bore of the base arm;
pivotally mounting a circular support ring between the first arm and the second arm;
positioning the rung shaft within the hollowed end of one of the rungs of the ladder;
supporting supports the paint and paint accessories within the support ring; and
providing an effective means of managing and securing paint, tools, and accessories conveniently and safely within reach while working on the ladder.

15. A ladder accessory device for holding paint and paint accessories on a ladder, the ladder having a plurality of rungs, each rung having hollowed ends, the ladder accessory device comprising:
a Y-shaped mounting bracket having a rounded first arm, a rounded second arm opposite the first arm, and a hollowed base arm extending in a substantially opposite direction from the first arm and the second arm;
a first thumb screw extending through the first arm;
a second thumb screw extending through the second arm;
a rung shaft receivable within the hollowed base arm, the rung shaft receivable within the hollowed end of one of the rungs of the ladder;
a rung shaft securing thumb screw threadably receivable within an aperture in the base arm for moving into and out of contact with the rung shaft thereby releasably securing at least a portion of the rung shaft within the base arm; and
a circular support ring supported by the first thumb screw and the second thumb screw and pivotally mounted between the first arm and the second arm allowing the support ring to be leveled between the first arm and the second arms;
wherein the circular support ring supports the paint and paint accessories providing an effective means of managing and securing paint, tools, and accessories conveniently and safely within reach while working on the ladder.

16. The ladder accessory device of claim 15 and further comprising:
a bubble leveler can be positioned on the mounting bracket.

17. The ladder accessory device of claim 15 and further comprising:
a lock ring for securing the rung shaft within the base arm of the mounting bracket.

18. The ladder accessory device of claim 15 further comprises:
a removable canvas bag mounted to the first arm of the mounting bracket; and
a mounting slot formed on the second arm of the mounting bracket for releasably holding a paint scraper.

19. The ladder accessory device of claim 15 and further comprising:
an tray insert having a magnetic bottom receivable within the support ring.

20. The ladder accessory device of claim 15 and further comprising:
a bucket receptacle receivable within the support ring;
wherein an interior of the bucket receptacle includes a gridded surface.
